(19) United States
(12) Patent Application Publication
(10) Pub. No.: US 2026/0062576 A1
(43) Pub. Date: Mar. 5, 2026

(54) Ink Composition For Ink Jet And Recording Method

(71) Applicant: SEIKO EPSON CORPORATION, Tokyo (JP)

(72) Inventors: Tasuku NAKAMURA, Matsumoto (JP); Kenta KIKUCHI, Suwa (JP)

(21) Appl. No.: 19/312,496

(22) Filed: Aug. 28, 2025

(30) Foreign Application Priority Data
Aug. 29, 2024 (JP) 2024-147767

(51) Int. Cl. C09D 11/326; C09D 11/037; C09D 11/36

(52) U.S. Cl. CPC C09D 11/326; C09D 11/037; C09D 11/36

(57) ABSTRACT

An ink composition for ink jet containing a pigment, in which the pigment includes a plant oil-derived carbon black and/or a recycled raw material-derived carbon black, and a petroleum-derived carbon black, a BET specific surface area of the plant oil-derived carbon black and/or the recycled raw material-derived carbon black is 50 m²/g or more and 120 m²/g or less, a BET specific surface area of the petroleum-derived carbon black is 160 m²/g or more and 280 m²/g or less, and the ink composition for ink jet is an aqueous ink.

The present application is based on, and claims priority from JP Application Serial Number 2024-147767, filed Aug. 29, 2024, the disclosure of which is hereby incorporated by reference herein in its entirety.

### BACKGROUND

### 1. Technical Field

The present disclosure relates to an ink composition for ink jet and a recording method.

### 2. Related Art

Ink jet recording methods can record high-definition images with a relatively simple apparatus and are rapidly developed in various fields. For example, JP-A-2023-128719 aims to provide an aqueous ink composition for ink jet having excellent environmental friendliness and storage stability and discloses an ink composition for ink jet that is an aqueous ink composition for ink jet containing a color material, derived from an organism, a dispersing agent derived from an organism, and an organic solvent derived from an organism, where the organic solvent includes a compound having a hydroxyl group, in which a solubility parameter based on the Hansen method is 24.0 (cal/cm³)^{1/2} or more.

By the way, in a case where a carbon black that is environmentally friendly, such as a plant oil-derived carbon black, is used as a carbon black that is used as a coloration material of an ink jet ink, there is still room for improvement in color developing properties and storage stability.

In addition, in a case where a plant oil-derived carbon black and a petroleum-derived carbon black are used in combination, there is still room for improvement in the continuous ejection stability and the recovery from clogging at the time of ink jet ejection.

### SUMMARY

An ink composition for ink jet according to the present disclosure according to the first embodiment contains a pigment, in which the pigment includes a plant oil-derived carbon black and/or a recycled raw material-derived carbon black, and a petroleum-derived carbon black, a BET specific surface area of the plant oil-derived carbon black and/or the recycled raw material-derived carbon black is 50 m²/g or more and 120 m²/g or less, a BET specific surface area of the petroleum-derived carbon black is 160 m²/g or more and 280 m²/g or less, and the ink composition for ink jet is an aqueous ink.

An ink composition for ink jet according to the present disclosure according to the second embodiment contains a pigment and a surfactant, in which the pigment includes a plant oil-derived carbon black and/or a recycled raw material-derived carbon black, and a petroleum-derived carbon black, the surfactant includes a surfactant A having an HLB value of 10 or more and less than 15 and a surfactant B which is an acetylene glycol-based surfactant having an HLB value of 3 or more and less than 10, and the ink composition for ink jet is an aqueous ink.

A recording method according to the present disclosure according to the first embodiment and the second embodiment is a method of adhering an ink using the above-described ink composition for ink jet to a recording medium.

### BRIEF DESCRIPTION OF THE DRAWINGS

FIG. 1 is Table 1 showing the composition and the evaluation results of each composition that is used examples.

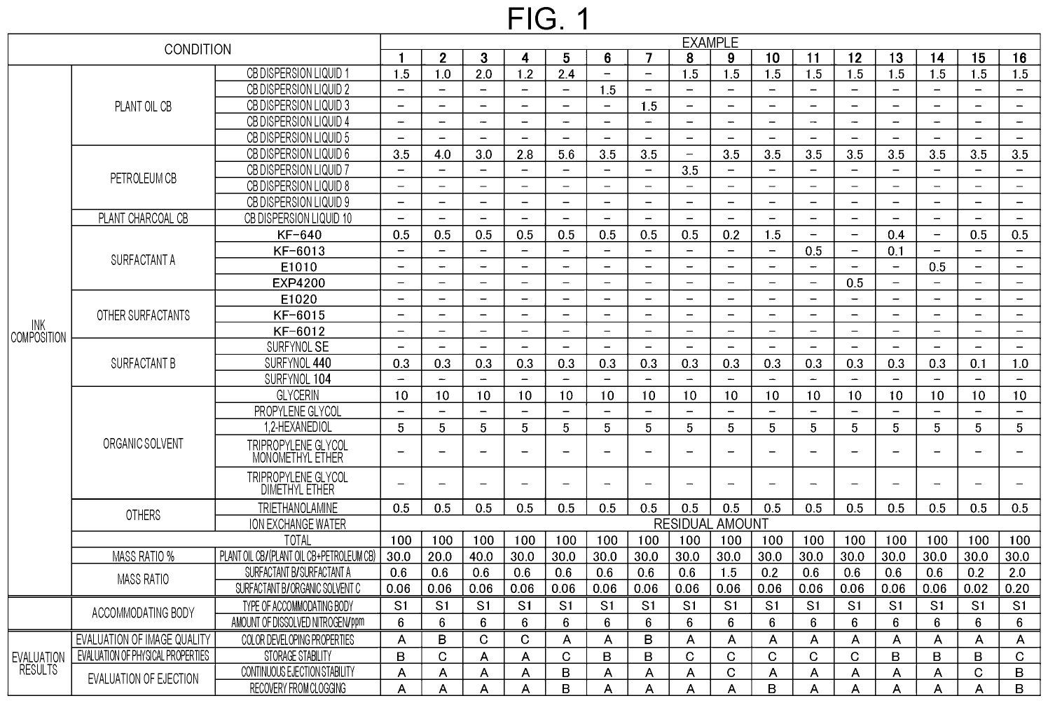

FIG. 2 is Table 2 showing the composition and the evaluation results of each composition that is used examples.

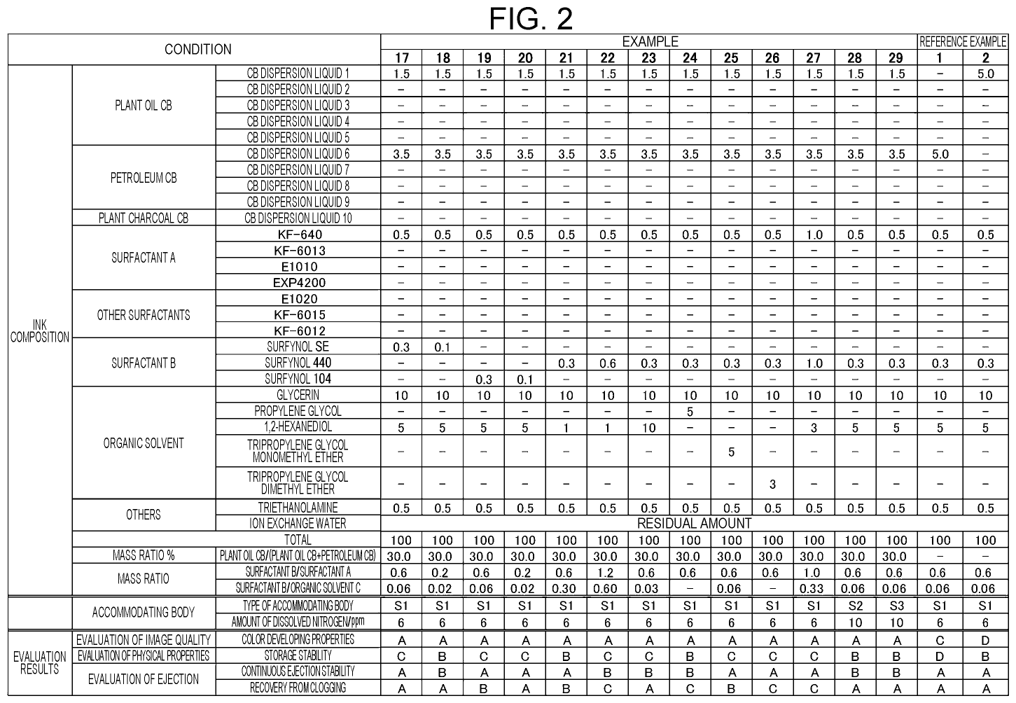

FIG. 3 is Table 3 showing the composition and the evaluation results of each composition that is used examples.

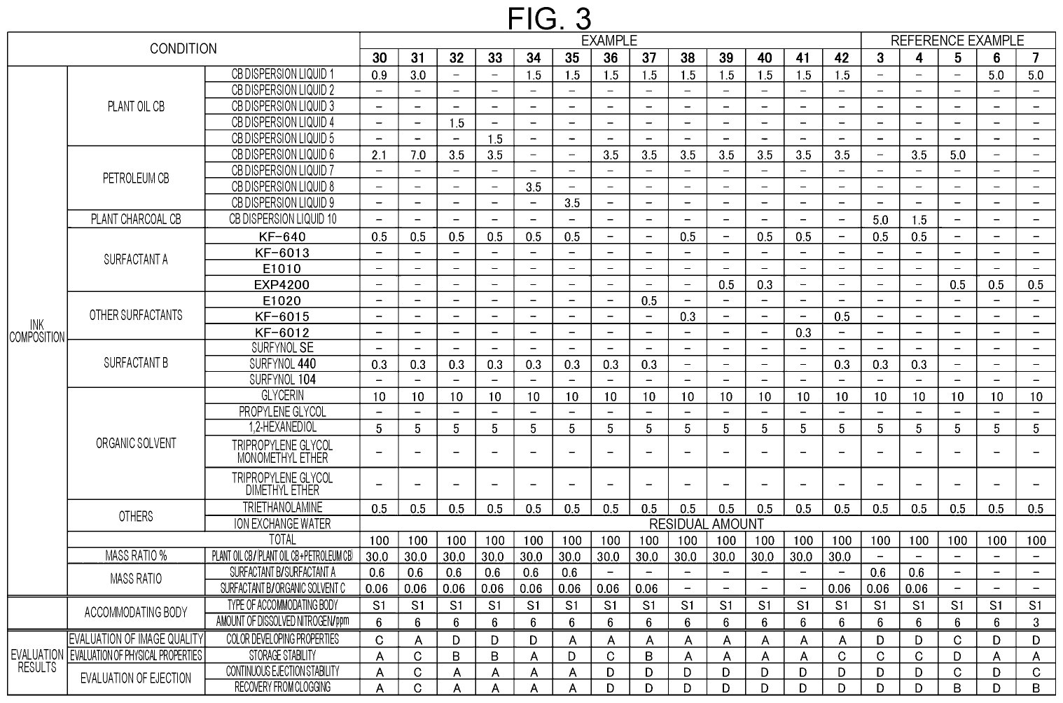

FIG. 4 is a view illustrating an example of a recording apparatus that is used in a recording method according to the first embodiment and the second embodiment.

FIG. 5 is a view illustrating an example of an ink accommodating body that is used in the recording method according to the first embodiment and the second embodiment.

FIG. 6 is a view illustrating another example of the ink accommodating body that is used in the recording method according to the first embodiment and the second embodiment.

FIG. 7 is a view illustrating another example of the recording apparatus that is used in the recording method according to the first embodiment and the second embodiment.

### DESCRIPTION OF EMBODIMENTS

Hereinafter, each embodiment is described in detail with reference to the drawings as necessary. However, the present disclosure is not limited thereto and can be variously modified without departing from the gist of the present disclosure. It is noted that in the drawings, the same elements are designated by the same reference numerals and the duplicated description will be omitted. In addition, the positional relationship, such as left, right, top, and bottom, should be based on the positional relationship illustrated in the drawings unless otherwise particularly specified. Further, the dimensional ratios in the drawings are not limited to the ratios illustrated in the drawings.

### 1. First Embodiment

First, an ink composition for ink jet in the first embodiment will be described.

### 1.1. Ink Composition for Ink Jet

An ink composition for ink jet according to the first embodiment contains a pigment, in which the pigment includes a plant oil-derived carbon black and/or a recycled raw material-derived carbon black, and a petroleum-derived carbon black, a BET specific surface area of the plant oil-derived carbon black and/or the recycled raw material-derived carbon black is 50 m²/g or more and 120 m²/g or less, a BET specific surface area of the petroleum-derived carbon black is 160 m²/g or more and 280 m²/g or less, and the ink composition for ink jet is an aqueous ink.

The plant oil-derived carbon black is useful as a carbon black derived from a natural product, which can contribute to reducing the amount of carbon dioxide discharged. In addition, the same production process as that of the petroleum carbon black can be used in terms of the fact that a liquid raw material (oil) is subjected to combustion and carbonization. Therefore, there is an advantage in that the particle size can be easily controlled. Further, impurities can be easily reduced by purifying the liquid raw material (plant oil).

However, since the raw material of the plant oil-derived carbon black contains various components, the secondary particles have an irregular structure instead of a spherical structure in a case where the raw material is carbonized. In addition, the plant oil-derived carbon black tends to have a small specific surface area, that is, the average particle diameter of the secondary particles tends to be large. As a result, in a case where the plant oil-derived carbon black is laminated on the recording medium, there is a concern that a gap is generated, the degree of blackness is lowered, and the color developing properties are inferior. The recycled raw material-derived carbon black also contains various components in the raw material, as in the case of the plant oil-derived carbon black, and thus similar problems may occur.

Therefore, in the first embodiment, in addition to the plant oil-derived carbon black and/or the recycled raw material-derived carbon black, a petroleum-derived carbon black having a BET specific surface area of 160 m²/g or more and 280 m²/g or less is used.

In the petroleum-derived carbon black having a BET specific surface area within the above-described range, the average particle diameter of the secondary particles is small. As a result, it is considered that the color developing properties are improved because the petroleum-derived carbon black can enter the gap of the plant oil-derived carbon black or the recycled raw material-derived carbon black and can fill the gap. On the other hand, a petroleum-derived carbon black having a relatively large specific surface area is likely to aggregate and tends to have low storage stability since the intermolecular force is likely to act. However, in the first embodiment, since a plant oil carbon black having a relatively small specific surface area is used in combination, it is possible to suppress the aggregation due to the action of intermolecular force, and the storage stability is also excellent.

Hereinafter, the components that can be contained in the ink composition according to the first embodiment and the production method will be described in detail.

### 1.1.1. Pigment

A pigment in the first embodiment includes a plant oil-derived carbon black and/or a recycled raw material-derived carbon black (hereinafter, also simply referred to as “plant oil-derived carbon black or the like”) having a BET specific surface area of 50 m²/g or more and 120 m²/g or less and a petroleum-derived carbon black having a BET specific surface area of 160 m²/g or more and 280 m²/g or less. The plant oil-derived carbon black and the recycled raw material-derived carbon black, which have a BET specific surface area in the above-described range tend to have excellent storage stability in terms of the simple body, in addition to being able to contribute to the reduction of the amount of carbon dioxide discharged. Further, the petroleum-derived carbon black having a large BET specific surface area has a small secondary particle diameter, can fill the gap that is generated on the recording medium by the plant oil-derived carbon black or the recycled raw material-derived carbon black, and thus has excellent color developing properties. On the other hand, such a petroleum-derived carbon black has a small secondary particle diameter, and thus aggregation is likely to occur and storage stability is poor. However, storage stability can also be improved by being used in combination with the plant oil-derived carbon black or the like.

The BET specific surface area of the plant oil-derived carbon black and the recycled raw material-derived carbon black is preferably 50 m²/g or more and 120 m²/g or less, 60 m²/g or more and 110 m²/g or less, or 80 m²/g or more and 100 m²/g or less. In a case where the BET specific surface area is within the above-described range, the storage stability and the color developing properties tend to be further improved.

The BET specific surface area of the petroleum-derived carbon black is preferably 160 m²/g or more and 280 m²/g or less, 180 m²/g or more and 270 m²/g or less, 200 m²/g or more and 250 m²/g or less, or 210 m²/g or more and 240 m²/g or less. In a case where the BET specific surface area is within the above-described range, the storage stability and the color developing properties tend to be further improved.

The BET specific surface area of carbon black can be obtained by putting carbon black into a sample cell, replacing the inside of the sample cell with nitrogen gas, drying the carbon black at 150° C. for 1.5 hours to remove moisture, and carrying measurement. Specifically, the mass of carbon black and the atmospheric pressure at the time of measurement are measured, and the nitrogen adsorption amount per 1 g at five points where the relative atmospheric pressures are 0.1, 0.15, 0.2, 0.25, and 0.3 times the atmospheric pressure is measured. The specific surface area is calculated according to the BET method from the nitrogen absorption amount at these five points, and then the specific surface area is calculated. Regarding the measurement apparatus, measurement can be carried out, for example, by using GEMINI 2360 (BET specific surface area measurement apparatus, manufactured by Micromeritics).

The BET specific surface area of the carbon black can be controlled by, for example, adjusting the temperature of the combustion gas at the time of production, the amount of oxygen-containing gas at the time of combustion, the supply amount of the amount of the raw material hydrocarbons (liquid oil such as plant oil or petroleum). For example, in a furnace method for producing carbon black by blowing a raw material such as a petroleum-based or coal-based oil into a high-temperature gas and causing incomplete combustion, the BET specific surface area of carbon black decreases as the temperature of the combustion gas flow into which the raw material hydrocarbon is introduced decreases.

### 1.1.1.1. Plant Oil-Derived Carbon Black

The plant oil-derived carbon black is a carbon black that is obtained by carbonizing a plant oil, and the production thereof is relatively easy since the production step is similar to that of the petroleum carbon black in terms of the fact that a liquid is subjected to combustion and carbonization. Specific examples of the plant oil-derived carbon black include carbon black obtained by using as a raw material, for example, a plant seed oil, tall oil, or wood tar, or a modified product such as a hydrogenated product of the plant seed oil, tall oil, or wood tar or a derivative thereof. More specific examples of the plant oil include, for example, avocado oil, linseed oil, almond oil, fennel oil, perilla oil, olive oil, orange oil, orange raffia oil, cocoa butter, chamomile oil, carrot oil, cucumber oil, apricot kernel oil, candlenut oil, walnut oil, wheat germ oil, sesame oil, rice oil, rice bran oil, sasanqua oil, safflower oil, salad oil, shea butter, soybean oil, tea oil, evening primrose oil, camellia oil, corn oil, rapeseed oil, persic oil, Carthamus tinctorius oil, castor oil, sunflower oil, grape seed oil, hazelnut oil, macadamia nut oil, cotton seed oil, meadowfoam oil, peanut oil, rose hip oil, turtle oil, cocoa butter, palm oil, palm kernel oil, Japan wax, coconut oil, the wood tar (wood tar oil) described above, tall oil, wood creosote, or a modified product such as a hydrogenated product of these oils or a derivative thereof. It is noted that the modified product is a product obtained by modifying a plant oil in a category in which the effect of the first embodiment is obtained.

### 1.1.1.2. Recycled Raw Material-Derived Carbon Black

The recycled raw material-derived carbon black is carbon black obtained by decomposing and purifying waste. Here, the waste is a used product containing carbon, such as rubber or a tire, and it is preferably a used product containing carbon black. The “used product” here includes not only a product that is actually used but also a product that is manufactured but discarded without being used. Such a recycled raw material-derived carbon black can contribute to reducing the amount of carbon dioxide discharged, and similar to the plant oil-derived carbon black, it contains various components in the raw material. Therefore, in a case where the carbon black is obtained, the secondary particles tend to be irregular, the particle diameter thereof tends to be large, and the storage stability tends to be low. Therefore, the effect of the first embodiment is remarkable. It is noted that the plant oil-derived carbon black is preferable in terms of easy availability and easy manufacturing.

The plant oil-derived carbon black and/or the recycled raw material-derived carbon black is preferably a self-dispersing pigment. By using such a carbon black, the effect of the present embodiment is more likely to be exhibited, and the storage stability and the color developing properties tend to be further improved, which is preferable.

Here, the self-dispersing pigment is a pigment that can be dispersed in an aqueous medium even without a dispersing agent. Examples of such self-dispersing pigments include a pigment that is dispersed in a solvent by being subjected to a physical and/or chemical surface treatment to introduce a hydrophilic functional group onto the pigment surface. Examples of the hydrophilic functional group include anionic groups such as a carboxyl group, a sulfo group, and a phosphorus-containing acid group. Examples of the phosphorus-containing acid group include a phosphate group and a phosphonate group. Alternatively, the plant oil-derived carbon black and/or the recycled raw material-derived carbon black may be used as a resin dispersion pigment in which the carbon black is dispersed in a solvent by a resin.

The total content of the plant oil-derived carbon black and the recycled raw material-derived carbon black is preferably 10% by mass or more and 50% by mass or less, 20% by mass or more and 40% by mass or less, 23% by mass or more and 37% by mass or less, or 25% by mass or more and 35% by mass or less, with respect to the total amount of the plant oil-derived carbon black, the recycled raw material-derived carbon black, and the petroleum-derived carbon black. In a case where the total content of the plant oil-derived carbon black and the recycled raw material-derived carbon black is within the above-described range, the storage stability and the color developing properties tend to be further improved.

The total content of the plant oil-derived carbon black and the recycled raw material-derived carbon black is preferably 0.5% by mass or more and 6% by mass or less, 1% by mass or more and 4% by mass or less, 1.3% by mass or more and 3% by mass or less, or 1.5% by mass or more and 2% by mass or less, with respect to the total amount of the ink composition for ink jet. In a case where the total content of the plant oil-derived carbon black and the recycled raw material-derived carbon black is within the above-described range, the storage stability and the color developing properties tend to be further improved.

### 1.1.1.3. Petroleum-Derived Carbon Black

The petroleum-derived carbon black is a carbon black that is obtained by carbonizing a petroleum-derived oil. In the first embodiment, since a petroleum-derived carbon black having a small secondary particle diameter is used, it is possible to fill the gap that is generated on the recording medium by the plant oil-derived carbon black and the recycled raw material-derived carbon black, and thus the color developing properties are excellent. On the other hand, such a petroleum-derived carbon black having a large specific surface area tends to have low storage stability since the intermolecular force is likely to act. However, in a case of being used in combination with a plant oil carbon black having a relatively small specific surface area, an ink composition for ink jet that is also excellent in storage stability is obtained.

In a case where the plant oil-derived carbon black and/or the recycled raw material-derived carbon black and the petroleum-derived carbon black are dispersed by being mixedly present in the ink composition, it is presumed that the intermolecular force between the petroleum-derived carbon blacks is alleviated, and the aggregation of the petroleum-derived carbon black is suppressed.

In a case where the petroleum-derived carbon black is a self-dispersing pigment, the effect of the present embodiment is more likely to be exhibited, and the storage stability and the color developing properties tend to be further improved, which is preferable. Alternatively, the petroleum-derived carbon black may be used as a resin dispersion pigment.

The content of the petroleum-derived carbon black is preferably 1% to 9% by mass, 2% to 8% by mass, 2.5% to 6% by mass, 3% to 5% by mass, or 3.3% to 3.8% by mass, with respect to the total amount of the ink composition for ink jet. In a case where the content of the petroleum-derived carbon black is within the above-described range, the storage stability and the color developing properties tend to be further improved.

The content of the petroleum-derived carbon black is preferably 30% to 99% by mass, 50% to 90% by mass, 55% to 85% by mass, or 65% to 75% by mass, with respect to the total content of the plant oil-derived carbon black, the recycled raw material-derived carbon black, and the petroleum-derived carbon black. In a case where the content of the petroleum-derived carbon black is within the above-described range, the storage stability and the color developing properties tend to be further improved.

The total content of the plant oil-derived carbon black, the recycled raw material-derived carbon black, and the petroleum-derived carbon black is preferably 4% by mass or more and 10% by mass or less, 4% by mass or more and 8% by mass or less, 4.3% by mass or more and 7% by mass or less, or 4.5% by mass or more and 6% by mass or less, with respect to the total amount of the ink composition for ink jet. In a case where the total content of the plant oil-derived carbon black, the recycled raw material-derived carbon black, and the petroleum-derived carbon black is within the above-described range, the storage stability and the color developing properties tend to be further improved.

The pigment contained in the ink composition according to the first embodiment may have a configuration of a pigment that is further contained in an ink composition according to the first embodiment described later.

Configurations other than those described above in the ink composition according to the first embodiment will be described later.

### 2. Second Embodiment

Next, an ink composition for ink jet in the second embodiment will be described.

### 2.1. Ink Composition for Ink Jet

An ink composition for ink jet according to the second embodiment is an aqueous ink that contains a pigment and a surfactant, in which the pigment includes a plant oil-derived carbon black and/or a recycled raw material-derived carbon black, and a petroleum-derived carbon black, the surfactant includes a surfactant A having an HLB value of 10 or more and less than 15 and a surfactant B which is an acetylene glycol-based surfactant having an HLB value of 3 or more and less than 10.

The plant oil-derived carbon black is useful as a carbon black derived from a natural product, which can contribute to reducing the amount of carbon dioxide discharged. In addition, the same production process as that of the petroleum carbon black can be used in terms of the fact that a liquid raw material (oil) is subjected to combustion and carbonization. Therefore, there is an advantage in that the particle size can be easily controlled. Further, impurities can be easily reduced by purifying the liquid raw material (plant oil).

However, since the plant oil, which is a raw material, contains various organic substances, the plant oil-derived carbon black to be produced contains, in the inside thereof, a large number of voids having sizes and shapes different from each other, and in addition, portions having high hydrophobicity and portions having low hydrophobicity may be mixedly present in the structure. In such a void, air bubbles are likely to remain, and the air bubbles remaining in the plant oil-derived carbon black act as air bubble nuclei and grow due to the dissolved nitrogen in the ink composition for ink jet. It is considered that the air bubbles grown in this manner are separated from the pigment, which is a factor that reduces the continuous ejection stability and the recovery from clogging.

In particular, the air bubbles are likely to grow in a case where the concentration of the dissolved nitrogen in the ink is relatively high. In addition, even in a case where the concentration of the dissolved nitrogen in the ink is not high at the time of the initial manufacturing, there is a concern that air permeates and the concentration of the dissolved nitrogen in the ink increases over time in a case where an ink accommodating body having low gas barrier properties is used.

In addition, the same also applies to the recycled raw material-derived carbon black obtained by thermally decomposing waste such as a tire, the plant oil-derived carbon black. Since the raw material waste contains various components, the recycled raw material-derived carbon black to be obtained contains, in the inside thereof, a large number of voids having sizes and shapes different from each other, and in addition, portions having high hydrophilicity and portions having low hydrophilicity may be mixedly present in the structure. Therefore, a problem of a decrease in continuous ejection stability and recovery from clogging may occur as in the case of the plant oil-derived carbon black.

In such a case, it is conceivable to add a surfactant to improve wettability; however, portions having different wettability coexist in the plant oil-derived carbon black and the recycled raw material-derived carbon black, and in addition, in a case where the petroleum-derived carbon black is used in combination, it was difficult to effectively improve wettability since the petroleum-derived carbon black also has different wettability.

Therefore, in the second embodiment, two kinds of surfactants, a surfactant A and a surfactant B, are used. As a result, it is possible to enhance the wettability in the inside of the voids of the plant oil-derived carbon black, the recycled raw material-derived carbon black, and the petroleum-derived carbon black, to promote the removal of fine air bubbles, and to prevent the voids from remaining. Specifically, the surfactant A having an HLB value of 10 or more and less than 15 can enhance the wettability of the portion having low hydrophobicity in the plant oil-derived carbon black or the recycled raw material-derived carbon black, and the surfactant B which is an acetylene glycol-based surfactant having an HLB value of 3 or more and less than 10 can enhance the wettability of the portion having high hydrophobicity in the plant oil-derived carbon black or the recycled raw material-derived carbon black.

It is presumed that due to the fact that the plant oil-derived carbon black or the plant oil is not completely carbonized, a part of the plant oil as an impurity is mixedly present in the carbon black, and the plant oil contains various organic substances, the fact that the degree of mixed presence of impurities is not constant depending on the portion of the carbon black, or the like, a portion having relatively high hydrophobicity is provided, and further, a portion having relatively low hydrophobicity is also provided. In addition, it is presumed that there are relatively a large number of portions having a relatively high hydrophobicity since the plant oil is used as a raw material.

It is presumed that the recycled raw material-derived carbon black also has a portion having low hydrophobicity and a portion having high hydrophobicity due to the fact that the raw material contains various components.

On the other hand, since the petroleum-derived carbon black does not use a plant oil as a raw material, it is presumed that the petroleum-derived carbon black has portions having relatively low hydrophobicity and furthermore, has a relatively large number of portions having relatively low hydrophobicity.

In a case where such a plant oil-derived carbon black and/or such a recycled raw material-derived carbon black and two kinds of surfactants, a surfactant A and a surfactant B which are described later, are used with respect to the petroleum-derived carbon black, it is considered that the wettability of the entire carbon black is improved, the removal of air bubbles from the plant oil-derived carbon black, the recycled raw material-derived carbon black, and the petroleum-derived carbon black is promoted, and the continuous ejection stability and the recovery from clogging can be favorably maintained even in such a case where the dissolved nitrogen increases over time.

### 2.1.1. Pigment

The pigment according to the second embodiment includes a plant oil-derived carbon black and/or a recycled raw material-derived carbon black, and a petroleum-derived carbon black. Due to containing various components as raw materials as described above, the plant oil-derived carbon black and/or the recycled raw material-derived carbon black contain voids derived from these components, which have sizes and shapes different from each other, and contain portions having high hydrophobicity and portions having low hydrophobicity. In addition, the petroleum-derived carbon black has a relatively large number of portions having low hydrophobicity. As a result, the ink composition for ink jet containing these makes it difficult to remove air bubbles and is likely to cause poor ejection. Therefore, the effect according to the present disclosure is remarkable. As the plant oil-derived carbon black, the recycled raw material-derived carbon black, and the petroleum-derived carbon black, those exemplified in the first embodiment can be appropriately used.

The plant oil-derived carbon black and/or the recycled raw material-derived carbon black, or the petroleum-derived carbon black is preferably a self-dispersing pigment. In a case where such a carbon black is used, the effect of the present embodiment is more likely to be exhibited, and the continuous ejection stability and the recovery from clogging tend to be preferably maintained, which is preferable. Further, the storage stability and color developing properties are more excellent, which is preferable. Alternatively, the plant oil-derived carbon black and/or the recycled raw material-derived carbon black, and the petroleum-derived carbon black may be used as a resin dispersion pigment.

The total content of the plant oil-derived carbon black and the recycled raw material-derived carbon black may be set within the same range as the ink composition according to the first embodiment described above with respect to the total amount of the plant oil-derived carbon black, the recycled raw material-derived carbon black, and the petroleum-derived carbon black, and in a case where the total content thereof is within the above-described range, the continuous ejection stability, the recovery from clogging, the storage stability, and the color developing properties tend to be further improved, which is preferable.

The total content of the plant oil-derived carbon black and the recycled raw material-derived carbon black may be set within the same range as the ink composition according to the first embodiment described above with respect to the total amount of the ink composition, and in a case where the total content thereof is within the above-described range, the continuous ejection stability, the recovery from clogging, the storage stability, and the color developing properties tend to be further improved, which is preferable.

The content of the petroleum-derived carbon black may be set within the same range as the ink composition according to the first embodiment described above with respect to the total amount of the ink composition for ink jet, and in a case where the content thereof is within the above-described range, the continuous ejection stability, the recovery from clogging, the storage stability, and the color developing properties tend to be further improved, which is preferable.

The content of the petroleum-derived carbon black may be set within the same range as the ink composition according to the first embodiment described above with respect to the total content of the plant oil-derived carbon black, the recycled raw material-derived carbon black, and the petroleum-derived carbon black, and in a case where the content thereof is within the above-described range, the continuous ejection stability, the recovery from clogging, the storage stability, and the color developing properties tend to be further improved, which is preferable.

The total content of the plant oil-derived carbon black, the recycled raw material-derived carbon black, and the petroleum-derived carbon black may be set within the same range as the ink composition according to the first embodiment described above with respect to the total amount of the ink composition for ink jet, and in a case where the total content thereof is within the above-described range, the continuous ejection stability, the recovery from clogging, the storage stability, and the color developing properties tend to be further improved, which is preferable.

The pigment contained in the ink composition of the second embodiment may further have the same configuration as the pigment contained in the ink composition according to the first embodiment described above.

### 2.1.2. Surfactant

The surfactant in the second embodiment includes a surfactant A having an HLB value of 10 or more and less than 15 and a surfactant B which is an acetylene glycol-based surfactant having an HLB value of 3 or more and less than 10. By including such a surfactant, it is possible to effectively enhance the wettability of the portion of the carbon black having high hydrophobicity and the portion of the carbon black having low hydrophobicity, and thus the storage stability, the continuous ejection stability, the recovery from clogging, and the like tend to be further improved.

The hydrophile-lipophile balance (HLB) value is a value for evaluating the hydrophilicity of a compound, which is proposed by Davies et al., and it is a numerical value determined by the Davies method defined in “J. T. Davies and E. K. Rideal, “Interface Phenomena” 2nd ed. Academic Press, New York 1963” and indicates a value calculated according to the following equation. The HLB value is a value for evaluating the hydrophilicity of a compound. The higher the HLB value is, the higher the hydrophilicity tends to be, and the lower the HLB value is, the higher the hydrophobicity tends to be.

$$HLB value = 7 + \sum [ 1 ] - \sum [ 2 ]$$

In the equation, [1] indicates the cardinal number of a hydrophilic group, and [2] indicates a cardinal number of a hydrophobic group.

### 2.1.2.1. Surfactant A

The surfactant A mainly enhances the wettability of the portion having low hydrophobicity in the petroleum-derived carbon black, further enhances the wettability of the portion having low hydrophobicity in the plant oil-derived carbon black or the recycled raw material-derived carbon black, and promotes the removal of air bubbles, and thus the ejection stability, the recovery from clogging, and the like can be favorably maintained even in such a case where an accommodating body in which the dissolved nitrogen increases over time is used.

The surfactant A is not particularly limited as long as the HLB value is 10 or more and less than 15; however, examples thereof include a silicone-based surfactant and an acetylene glycol-based surfactant. The surfactant A may be a commercially available product, and examples thereof include KF-640 and KF-6013 (silicone-based surfactant, manufactured by Shin-Etsu Silicone Co., Ltd.), and E1010 and EXP4200 (acetylene glycol-based surfactant, manufactured by Nissin Chemical Co., Ltd.).

Among these, one or more selected from the group consisting of a silicone-based surfactant and an acetylene glycol-based surfactant are preferable, and an acetylene glycol-based surfactant is more preferable. In a case where such a surfactant A is used, the storage stability and the continuous ejection stability tend to be further improved. In addition, the acetylene glycol-based surfactant is less likely to foam and has a carbon skeleton similar to that of carbon black, and thus the affinity with carbon black tends to be high, and the efficiency of removing air bubbles tends to be high.

The HLB value of the surfactant A is 10 or more and less than 15, and it is preferably 11 or more and 14.5 or less, or 12 or more and 14 or less. In a case where the HLB value of the surfactant A is set within the above-described range, the storage stability tends to be further improved.

The commercially available product of the silicone-based surfactant having an HLB value of 10 or more and less than 15 is not particularly limited; however, examples thereof include KF-640 and KF-6013 (manufactured by Shin-Etsu Silicone Co., Ltd.).

The commercially available products of acetylene glycol-based surfactants having an HLB value of 10 or more and less than 15 are not particularly limited; however, examples thereof include E1010 and EXP4200 (manufactured by Nissin Chemical Co., Ltd.).

The acetylene glycol-based surfactant to be used as the surfactant A is preferably an acetylene glycol-based surfactant having a polyether-modified group. Examples of the acetylene glycol-based surfactant to be used as the surfactant A include a compound represented by a formula that is the same as Formula (1) described later, except that in Formula (1), m and n are each independently an integer of 1 or more and m+n is set to be 50 or less. m and n are preferably each independently 3 to 40, 4 to 30, 6 to 20, 8 to 16, or 11 to 15.

The content of the surfactant A is preferably 0.05% by mass or more and 2.0% by mass or less, 0.1% by mass or more and 1.5% by mass or less, 0.2% by mass or more and 1.3% by mass or less, 0.3% by mass or more and 1.1% by mass or less, or 0.4% by mass or more and 0.9% by mass or less, with respect to the total amount of the ink composition for ink jet. In a case where the content of the surfactant A is within the above-described range, the continuous ejection stability and the storage stability tend to be further improved.

### 2.1.2.2. Surfactant B

The surfactant B is an acetylene glycol-based surfactant having an HLB value of 3 or more and less than 10. By using an acetylene glycol-based surfactant having an HLB value of 3 or more and less than 10, it is possible to mainly enhance the wettability of the portion having high hydrophobicity in the plant oil-derived carbon black or the recycled raw material-derived carbon black, to promote the removal of air bubbles, and to favorably maintain the ejection stability. In addition, the acetylene glycol-based surfactant is a surfactant that is less likely to foam and has a carbon skeleton similar to that of carbon black, and thus it is considered to have a high affinity and a high efficiency of removing air bubbles as compared with other surfactants.

The surfactant B is not particularly limited as long as it is an acetylene glycol-based surfactant having an HLB value of 3 or more and less than 10; however, examples of the commercially available product thereof include SURFYNOL SE, SURFYNOL 440, and SURFYNOL 104 (product name, manufactured by Nissin Chemical Co., Ltd.).

The acetylene glycol-based surfactant to be used as the surfactant B is preferably an acetylene glycol-based surfactant that has or does not have a polyether-modified group. Examples thereof include a compound represented by the following Formula (1).

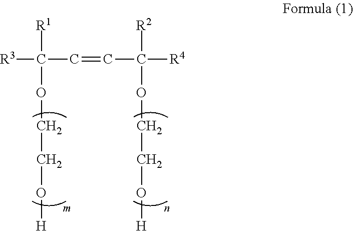

R1 to R4 each independently represent an alkyl group having 1 to 4 carbon atoms, m and n each independently represent an integer of 0 or 1 or more and satisfy m+n=20 or less.

m and n are preferably each independently 10 or less, more preferably 5 or less, still more preferably 2 or less, and particularly preferably 0.

Examples of R1 to R4 include methyl, ethyl, n-propyl, iso-propyl, n-butyl, sec-butyl, and tert-butyl, which is preferable.

The HLB value of the surfactant B is 3 or more and less than 10, and it is preferably 4 or more and 9.5 or less, 5 or more and 9 or less, or 6.5 or more and 8.5 or less. In a case where the HLB value of the surfactant B is set within the above-described range, the storage stability tends to be further improved.

The content of the surfactant B is preferably 0.05% by mass or more and 1.5% by mass or less, 0.1% by mass or more and 1.0% by mass or less, 0.15% by mass or more and 0.75% by mass or less, or 0.2% by mass or more and 0.5% by mass or less, with respect to the total amount of the ink composition for ink jet. In a case where the content of the surfactant B is within the above-described range, the continuous ejection stability and the storage stability tend to be further improved.

The mass ratio (B/A) of the content of the surfactant B to the content of the surfactant A is preferably 0.01 or more and 2.0 or less, 0.1 or more and 1.0 or less, 0.2 or more and 0.9 or less, 0.3 or more and 0.8 or less, or 0.4 or more and 0.7 or less. In a case where the mass ratio of the content of the surfactant B to the surfactant A is set within the above-described range, the continuous ejection stability and the storage stability tend to be further improved.

### 2.1.2.3. Other Surfactants

Other surfactants are not particularly limited; however, examples thereof include a silicone-based surfactant, an acetylene glycol-based surfactant, and a fluorine-based surfactant.

Examples of the silicone-based surfactant include a polysiloxane-based compound, and polyether-modified organosiloxane.

The acetylene glycol-based surfactant is not particularly limited; however, examples thereof include one or more selected from an alkylene oxide adduct of 2,4,7,9-tetramethyl-5-decyne-4,7-diol and 2,4,7,9-tetramethyl-5-decyne-4,7-diol, and an alkylene oxide adduct of 2,4-dimethyl-5-decyne-4-ol and 2,4-dimethyl-5-decyne-4-ol. It is noted that among the above-described examples, those that do not correspond to the above-described surfactant A and surfactant B are other surfactants.

The content of the other surfactants may be 0% by mass or more and 0.5% by mass or less, 0.01% by mass or more and 0.4% by mass or less, 0.02% by mass or more and 0.3% by mass or less, 0.03% by mass or more and 0.2% by mass or less, or 0.04% by mass or more and 0.1% by mass or less, with respect to the total amount of the ink composition for ink jet. The other surfactants may not be contained. In a case where the content of the other surfactants is set within the above-described range, the continuous ejection stability and the storage stability tend to be further improved.

The total content of the surfactant is preferably 0.05% to 5% by mass, 0.1% to 2% by mass, 0.2% to 1.5% by mass, or 0.7% to 1.2% by mass, with respect to the total amount of the ink composition for ink jet. In a case where the total content of the surfactant is set within the above-described range, the continuous ejection stability, the recovery from clogging, and the storage stability tend to be further improved.

Hereinafter, configurations of the ink composition for ink jet other than those described above in the first embodiment and the second embodiment will be described.

### 3.1 Surfactant

The surfactant of the ink composition for ink jet in the second embodiment is as described above.

The ink composition for ink jet in the first embodiment may contain a surfactant. In a case where a surfactant is contained, the storage stability tends to be further improved.

The surfactant is not particularly limited; however, examples thereof include a silicone-based surfactant, an acetylene glycol-based surfactant, and a fluorine-based surfactant. One kind of surfactant may be used alone, or two or more kinds thereof may be used in combination.

The surfactant may be the same as the surfactant that is contained or may be contained in the ink composition according to the second embodiment described above, and for example, the surfactant A, the surfactant B, and other surfactants may be contained, which is preferable.

### 3.2. Organic Solvent

The ink composition for ink jet in the first embodiment and the second embodiment may contain an organic solvent. In a case where an organic solvent is contained, the storage stability, recovery from clogging, continuous ejection stability, and the like of the ink composition for ink jet tend to be further improved.

Examples of the organic solvent include water-soluble organic solvents such as polyols and glycol ethers. One kind of organic solvent may be used alone, or two or more kinds thereof may be used in combination.

Examples of the polyols include ethylene glycol, propylene glycol, 1,2-propanediol, 1,2-butanediol, 1,2-pentanediol, 1,2-hexanediol, 1,2-octanediol, 1,3-propanediol, 1,4-butanediol, 1,6-hexanediol, diethylene glycol, triethylene glycol, propylene glycol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, and glycerin.

The polyols are compounds having two or more hydroxyl groups in the molecule, and examples thereof preferably include an alkanediol, a condensate in which intermolecular hydroxyl groups of alkanediols are condensed, and triols.

In addition, examples of the alkanediol and the condensate in which intermolecular hydroxyl groups of alkanediols are condensed include a diol of an alkane having 4 or less carbon atoms, and a condensate in which intermolecular hydroxyl groups of diols of alkanes having 4 or less carbon atoms are condensed, which is preferable. The above-described number of carbon atoms in these compounds is more preferably 2 to 3.

Alternatively, examples of the alkanediol include a diol of an alkane having 5 to 10 carbon atoms, which is preferable. A diol of an alkane having 6 to 8 carbon atoms is more preferable. In addition, 1,2-alkanediol is preferable.

Examples of the triols include triols of alkanes having 3 to 5 carbon atoms, which is preferable.

The glycol ethers may be any monoether or diether of alkylene glycols, and alkyl ethers are preferable. Specific examples include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, and tripropylene glycol monobutyl ether; alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether; and the like.

Among the above organic solvents, the ink composition for ink jet according to the first embodiment may contain an organic solvent C having an SP value of 8 (cal/cm³)^{1/2} or more and 14 (cal/cm³)^{1/2} or less. In a case where an organic solvent C having an SP value of 8 (cal/cm³)^{1/2} or more is contained, the compatibility of the components contained in the ink composition is improved, and the storage stability and the continuous ejection stability of the ink composition tend to be further improved. On the other hand, in a case where the SP value of the organic solvent C is 14 (cal/cm³)^{1/2} or less, the solubility of the surfactant B tends to be further improved. In particular, the surfactant B has a relatively low solubility in water and is likely to cause poor ejection in a state where the ink is dried and the water is reduced in the nozzle. However, in a case where the organic solvent C is contained, the continuous ejection stability tends to be further improved even in such a state.

The SP value in the present specification is a solubility parameter that is calculated based on the Hansen method. According to the Hansen method, the SP value is represented by the following equation.

$${δ}^{2} = {δ}_{d}^{2} + {δ}_{p}^{2} + {δ}_{h}^{2}$$

In the equation, da is a solubility parameter corresponding to a dispersion force term, op is a solubility parameter corresponding to a dipolar force term, and on is a solubility parameter corresponding to a hydrogen bonding force term.

The SP value is based on the idea that two substances having similar intermolecular interactions are likely to be dissolved mutually. The SP value can be approximately estimated by calculation and can also be experimentally and empirically determined, and there are many substances of which the SP values are described in the documents. In the first embodiment, a value derived by using the HSPiP, which is calculation software can be used as the SP value.

In addition, the unit of the SP value in the embodiment is (cal/cm³)^{1/2}. It is noted that the range of the SP value of 8 (cal/cm³)^{1/2} or more and 14 (cal/cm³)^{1/2} or less can also be expressed as 16.4 (J/cm³)^{1/2} or more and 28.6 (J/cm³)^{1/2} or less by using another unit.

The SP value of the organic solvent C is preferably 8 (cal/cm³)^{1/2} or more and 14 (cal/cm³)^{1/2} or less, 9 (cal/cm³)^{1/2} or more and 13 (cal/cm³)^{1/2} or less, or 10 (cal/cm³)^{1/2} or more and 12.5 (cal/cm³)^{1/2} or less.

The content of the organic solvent C is preferably 1% to 15% by mass, 2% to 9% by mass, 3% to 8% by mass, or 4% to 7% by mass, with respect to the total amount of the ink composition for ink jet. In a case where the content of the organic solvent C is set within the above-described range, the storage stability, the continuous ejection stability, the recovery from clogging, and the like tend to be further improved.

The organic solvent C is preferably polyols or glycol ethers and is more preferably an alkanediol.

The mass ratio (B/C) of the content of the surfactant B to the content of the organic solvent C is preferably 0.8 or less, 0.6 or less, 0.5 or less, 0.4 or less, 0.3 or less, 0.2 or less, or 0.15 or less. In addition, the mass ratio (B/C) is preferably 0.01 or more, 0.02 or more, or 0.03 or more. In a case where the mass ratio of the content of the surfactant B to the organic solvent C is set within the above-described range, the continuous ejection stability and the storage stability tend to be further improved.

The content of the organic solvent is preferably 3% to 50% by mass, 5% to 40% by mass, 10% to 30% by mass, 15% to 25% by mass, or 17% to 22% by mass, with respect to the total amount of the ink composition for ink jet. Alternatively, 12% to 20% by mass is preferable, and 13% to 17% by mass is more preferable. In a case where the content of the organic solvent C is set within the above-described range, the storage stability and the continuous ejection stability tend to be further improved.

Among the organic solvents, an organic solvent having a standard boiling point of 160° C. or higher is preferable, and the standard boiling point is more preferably 170° C. to 350° C., 180° C. to 300° C., 190° C. to 250° C., or 200° C. to 230° C.

In addition, it is preferable to contain an organic solvent having a standard boiling point of 280° C. or higher, and it is preferable to contain, in the ink, 5% to 20% by mass of an organic solvent having a standard boiling point of 280° C. or higher.

The organic solvent may include other organic solvents. The other organic solvents are not particularly limited, and examples thereof include those other than the polyols and the glycol ethers. The content of the other organic solvents is preferably 0% to 20% by mass, 1% to 15% by mass, or 3% to 10% by mass, with respect to the total amount of the ink composition for ink jet. In a case where the content of the other organic solvents is set within the above-described range, the storage stability and the recovery from clogging tend to be further improved.

### 3.3. pH Adjusting Agent

The ink composition for ink jet in the first embodiment and the second embodiment may contain a pH adjusting agent as necessary. Examples of the pH adjusting agent include inorganic acids (for example, sulfuric acid, hydrochloric acid, nitric acid, and the like), inorganic bases (for example, lithium hydroxide, sodium hydroxide, potassium hydroxide, ammonia, and the like), organic acids (for example, adipic acid, citric acid, succinic acid, and the like), and organic bases (triethanolamine, diethanolamine, monoethanolamine, triisopropanolamine, diisopropanolamine, and tris(hydroxymethyl)aminomethane). One kind of pH adjusting agent may be used alone, or two or more kinds thereof may be used in combination.

The content of the pH adjusting agent is preferably 0.01% to 5% by mass, 0.05% to 3% by mass, 0.1% to 1% by mass, or 0.3% to 0.8% by mass, with respect to the total amount of the ink composition for ink jet. In a case where the content of the pH adjusting agent is set within the above-described range, the storage stability and the continuous ejection stability tend to be further improved.

### 3.4. Water

The ink composition for ink jet according to the first embodiment and the second embodiment is an aqueous ink containing water. The aqueous ink composition for ink jet is an ink composition for ink jet containing at least water as a main solvent component of the ink.

The content of water is preferably 40% to 99% by mass, 50% to 98% by mass, 60% to 95% by mass, 65% to 85% by mass, 70% to 80% by mass, or 75% to 79% by mass, with respect to the total amount of the ink composition for ink jet. In a case where the content of the water is set within the above-described range, the storage stability and the continuous ejection stability tend to be further improved.

### 3.5. Other Components

The ink composition may contain components other than the above-described components. Various additives such as a dissolution aid, a viscosity adjusting agent, an antioxidant, a preservative, a fungicide, and a corrosion inhibitor can be appropriately added as other components.

### 3.6 Recording Medium

The recording medium to be used in the first embodiment and the second embodiment is not particularly limited, and examples thereof include an absorbent recording medium, a low-absorbent recording medium, and a non-absorbent recording medium.

Among these, an absorbent recording medium is preferable. In a case of being used for an absorbent recording medium, the color developing properties tend to be further improved.

Examples of the absorbent recording medium include a plain paper, such as an electrophotographic paper having high ink permeability, an ink jet printing paper (ink jet paper for exclusive use for ink jet provided with an ink absorption layer containing silica particles or alumina particles or an ink absorption layer containing a hydrophilic polymer, such as polyvinyl alcohol (PVA) or polyvinyl pyrrolidone (PVP)), and the like.

Examples of the low-absorbent recording medium include an art paper, a coated paper, a cast paper, and the like, which have relatively low ink permeability and are used in general offset printing.

Examples of the non-absorbent recording medium include a film or a plate of a plastic such as polyvinyl chloride, polyethylene, polypropylene, polyethylene terephthalate (PET), polycarbonate, polystyrene, or polyurethane; a plate of a metal such as iron, silver, copper, or aluminum; or a metal plate which is manufactured by vapor deposition of these various metals or a plastic film, or a plate of an alloy such as stainless steel or brass; and a recording medium in which a film of a plastic such as polyvinyl chloride, polyethylene, polypropylene, polyethylene terephthalate (PET), polycarbonate, polystyrene, or polyurethane is adhered (coated) to a paper base material.

Here, the term “absorbent recording medium” refers to a medium in which the amount of water absorbed from the start of contact to 30 msec in the Bristow method is more than 10 mL/m², and the terms “low-absorbent recording medium and non-absorbent recording medium” refers to a recording medium in which the amount of water absorbed is 10 mL/m² or less. The Bristow method is the most popular method for measuring the amount of liquid absorption in a short time and is also adopted by Japan Technical Association of the Pulp and Paper Industry (JAPAN TAPPI). Details of the test method are laid out in the standard No. 51 “JAPAN TAPPI Paper Pulp Test Method 2000 Edition” under “Paper and paperboard-Liquid absorbency test method-Bristow method”.

### 4. Ink Accommodating Body

The ink accommodating body according to the first embodiment and the second embodiment is an ink accommodating body that accommodates the ink composition according to the first embodiment or the second embodiment described above, and it has the ink composition for ink jet according to the first embodiment or the second embodiment and a container that accommodates the ink composition for ink jet. It is noted that in the first embodiment and the second embodiment, the ink accommodating body refers to a state where the container accommodates the ink.

The concentration of the dissolved nitrogen in the accommodating body of the ink composition accommodated in the ink accommodating body is preferably 2 ppm or more and 100 ppm or less, 3 ppm or more and 50 ppm or less, 4 ppm or more and 10 ppm or less, or 5 ppm or more and 8 ppm or less. As the nitrogen concentration in the ink increases, the plant oil-derived carbon black or the recycled raw material-derived carbon black, which has a lot of voids, easily incorporates nitrogen. Therefore, the effect of the second embodiment is remarkable. The concentration of the dissolved nitrogen in the ink may be equal to or lower than a predetermined value at the time of shipment of the ink accommodating body, and may be equal to or higher than the predetermined value after the shipment and until the start of use in the printer.

In a case where those having a high concentration of dissolved nitrogen in the container are allowed, for example, carrying out sufficient deaeration during ink preparation can be omitted, and the number of ink manufacturing man-hours can be reduced. In addition, it is not necessary to use an ink container having high gas barrier properties, and thus the degree of freedom of the container design is improved. As a result, for example, a member having excellent flexibility can be used, which makes it possible to increase the capacity of the container and reduce the cost.

### 4.1. Container

The container is not particularly limited; however, examples thereof include an ink cartridge, an ink pack, an ink bottle, an ink tank, a bottle, and a can. Among these, from the viewpoint of universal use, an ink cartridge, an ink pack, an ink bottle, or an ink tank is preferable, and an ink pack or an ink bottle is more preferable.

The capacity of the container is preferably 20 ml or more, 80 ml or more, 100 ml or more, or 150 ml or more. In addition, it is 5 l or less, 1 l or less, 500 ml or less, or 300 ml or less. In a case where the capacity is equal to or larger than the above-described range, a large amount of the ink can be accommodated and thus is useful; however, the size and weight of the container are increased, and the strength and flexibility of the member of the container become more important. In a case where the capacity is equal to or smaller than the above-described range, it is possible to avoid the size and weight of the container from being excessively large, which is preferable.

### 4.1.1. Ink Pack

The ink pack is not particularly limited; however, it may have, for example, a pack main body that accommodates the ink, and an ink supply port. The constituent material of the pack main body is not particularly limited; however, for example, the constituent material thereof may have a multilayer structure in which a resin film base material layer serving as a base material for ensuring a basic strength is provided and a gas barrier layer for imparting gas barrier properties to the resin film base material layer are laminated as necessary.

The resin that constitutes the resin film base material layer is not particularly limited; however, examples thereof include a polyester resin and a polyolefin resin.

The gas barrier layer is not particularly limited, and examples thereof include a resin layer having excellent gas barrier properties, a vapor deposition layer of a metal or a metal compound, and a layer to which a metal foil layer is attached. It is noted that, for example, a layer to which a metal foil layer such as an aluminum foil layer is attached has higher gas barrier properties, and thus the concentration of the dissolved nitrogen is unlikely to increase even in a case of being stored for a long period of time.

On the other hand, those in which a resin layer or a vapor deposition layer of a metal or a metal compound is used as the gas barrier layer are useful because they are unlikely to be broken and have excellent flexibility. However, since the gas barrier properties are slightly low as compared with the metal foil layer, the concentration of the dissolved nitrogen tends to increase during storage, and even in a case where the concentration of the dissolved nitrogen is low immediately after the ink was poured into the ink accommodating body, the concentration of the dissolved nitrogen tends to increase during use. Therefore, the present disclosure is particularly useful.

The resin layer having excellent gas barrier properties is not particularly limited, and examples thereof include nylon, an ethylene vinyl alcohol copolymer resin, and polyvinylidene chloride. Since the gas barrier properties are slightly inferior to those of the metal or metal compound layer, it is preferable to use the resin layer after increasing the thickness to be slightly thicker than the metal film.

Those in which a vapor deposition layer of a metal or a metal compound is used as the gas barrier layer are useful because the thickness thereof is thin and the flexibility is excellent as compared with the metal foil. The vapor deposition layer of the metal or metal compound is not particularly limited, and examples thereof include an aluminum vapor deposition layer and a vapor deposition layer of alumina, silica, or the like.

The ink pack having the multilayer structure described above has the gas barrier layer, and thus the concentration of the dissolved nitrogen is less likely to increase even in a case of being stored for a long period of time; however, there may be a limitation on the gas barrier properties in order to ensure the flexibility of the ink pack and the like. Therefore, there is a high possibility that the concentration of the dissolved nitrogen easily increases, and thus the present embodiment is particularly useful. In particular, it is particularly useful to adopt the ink accommodating body according to the second embodiment.

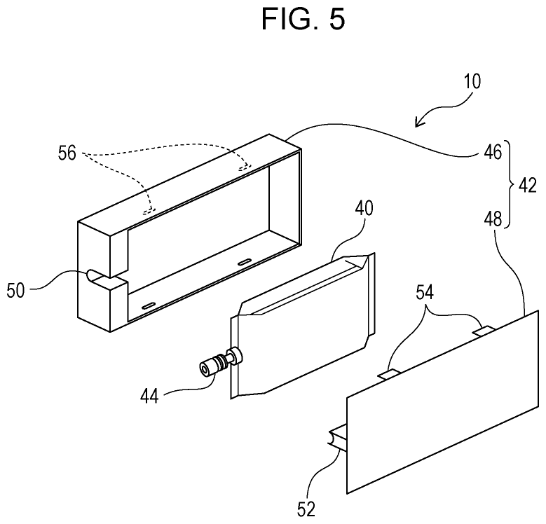

FIG. 5 illustrates an example of an ink pack of the container according to the present embodiment. FIG. 5 is an exploded perspective view of the ink pack. An ink cartridge 10 is composed of an ink pack 40 to be filled with an ink, and a cartridge case 42 which is composed of a main body case 46 that houses the ink pack 40 in the inside and protects the ink pack 40, and a lid portion 48. The ink pack 40 includes an ink supply port 44. The main body case 46 includes a notch portion 50 and a groove portion 56, and the lid portion 48 includes a pressing portion 52 and a hook portion 54. In the ink cartridge 10, the ink pack 40 is housed in the main body case 46 and the lid portion 54, and in this case, the ink supply port 44 is fitted into the notch portion 50 and then is fixed by being sandwiched between the pressing portion 52 and the notch portion 50. In addition, the main body case 46 and the lid portion 54 are sealed by fitting the hook portion 54 into the groove portion 56. The film-shaped member that constitutes the ink pack 40 and accommodates the ink in the ink pack may be any member that constitutes the ink pack described above.

### 4.1.2. Ink Bottle

The ink bottle is not particularly limited, and examples thereof include an ink bottle for replenishing an ink in a printer having a continuous ink supply system (CISS). The ink bottle is not particularly limited; however, it may have, for example, an ink ejection port and a bottle main body that accommodates the ink.

The ink bottle is preferably a resin bottle. The present disclosure is excellent in terms of light weight, cost, and the like, and the airtightness of the lid and the gas barrier properties of the container itself are low, and thus the concentration of the dissolved nitrogen tends to be high. Therefore, the present disclosure is particularly useful.

The resin that constitutes the bottle main body is not particularly limited; however, examples thereof include a polyester resin and a polyolefin resin. Such a member is excellent in impact resistance, which is preferable; however, on the other hand, the gas barrier properties are relatively low, and thus it is particularly useful to adopt the ink accommodating body according to the second embodiment.

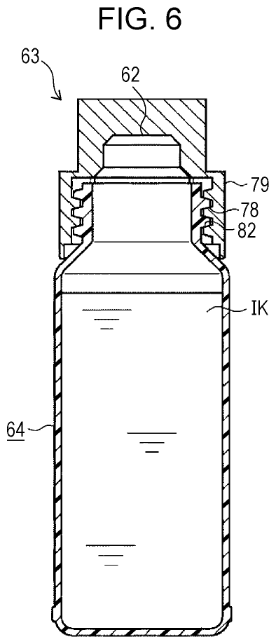

An example of an ink bottle is illustrated in FIG. 6 as the container according to the present embodiment. FIG. 6 is a cross-sectional view of an example of an ink bottle. The ink composition IK described above is accommodated in an ink bottle 63. The ink bottle 63 has a cylindrical container main body portion 64 as a main body thereof. An ink outlet 62 that allows an ink to flow out from the inside of the container main body portion 64 is formed to be opened in the tip portion of the container main body portion 64. In a case where the ink bottle 63 is stored, a bottomed cylindrical cap 79 covers a part of the container main body portion 64 so that the ink outlet 62 is surrounded, and it seals the ink outlet 62 from the outside. A spiral screw 78 is formed in the inside of the cap 79, and the cap 79 is engaged with and then fixed to a spiral screw 82 formed on the outer surface of the container main body portion 64, by rotation. In a case where the ink is caused to flow out, the cap 79 is removed.

The container main body portion 64 in the ink bottle 63 is a member that forms a bottle shape that is able to accommodate the ink composition in the inside thereof.

Examples of the member that forms the bottle shape include those made of a polyolefin resin such as polypropylene, which is preferable. Such a member is excellent in impact resistance, which is preferable; however, on the other hand, the gas barrier properties are relatively low, and thus it is particularly useful to adopt the ink accommodating body according to the present embodiment.

### 5. Ink Jet Recording Method

The ink jet recording method according to the first embodiment and the second embodiment includes ejecting the ink composition for ink jet from an ink jet head by using a predetermined ink jet head to adhere the ink composition for ink jet to a recording medium.

### 6. Ink Jet Recording Apparatus

The ink jet recording apparatus according to the first embodiment and the second embodiment includes the above-described ink composition and an ink jet head having a nozzle for ejecting the above-described ink composition to a recording medium. Furthermore, it further includes a supply flow channel through which the above-described ink composition flows and which is coupled to the ink jet head, and a filter unit provided in the supply flow channel of the ink jet head.

A mounting portion (not illustrated in the drawing) in which the ink accommodating body is mounted is further provided, and the ink is supplied from the ink accommodating body to the ink jet head. In the present example, an ink pack is preferably used as the ink accommodating body.

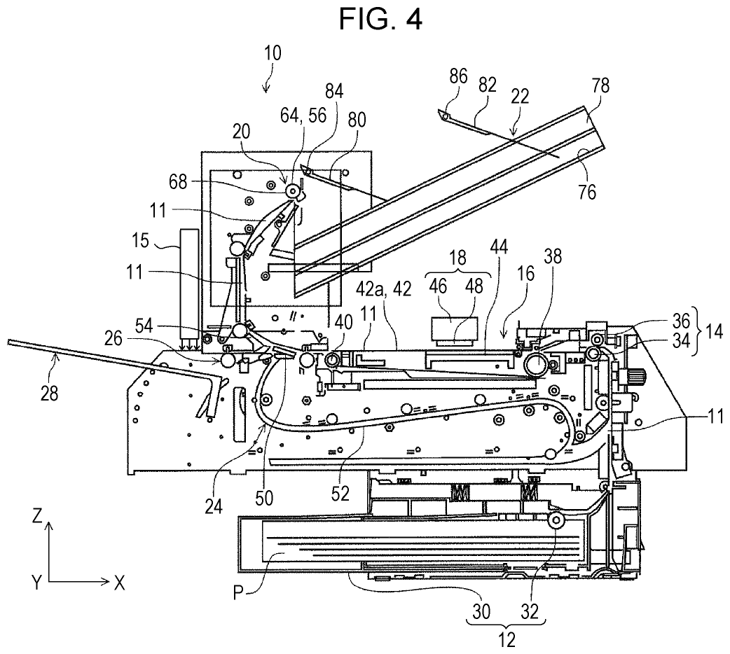

FIG. 4 illustrates an example of an ink jet recording apparatus that can be used in the first embodiment and the second embodiment. The ink jet recording apparatus according to the first embodiment and the second embodiment will be further described with reference to FIG. 4. In the X-Y-Z coordinate system illustrated in FIG. 4, the X direction indicates the length direction of the recording medium, the Y direction indicates the width direction of the recording medium in the transport path in the recording apparatus, and the Z direction indicates the height direction of the apparatus.

One example of the recording apparatus 10 is a line-type ink jet printer that is able to carry out high-speed and high-density printing. The recording apparatus 10 includes a feeding portion 12 that stores a recording medium P such as paper, a transport portion 14, a belt transport portion 16, a recording portion 8, a face-down (Fd) discharging portion 20 as a “discharging portion”, a face-down (Fd) placing portion 22 as a “placing portion”, a reversing path portion 24 as a “reversing transport mechanism”, a face-up (Fu) discharging portion 26, and a face-up (Fu) placing portion 28.

The feeding portion 12 is disposed at the lower portion of the apparatus in the recording apparatus 10. The feeding portion 12 includes a feeding tray 30 that stores the recording medium P and a feeding roller 32 that feeds the recording medium P stored in the feeding tray 30 to a transport path 11.

The recording medium P stored in the feeding tray 30 is fed to the transport portion 14 along the transport path 11 by the feeding roller 32. The transport portion 14 includes a transport driving roller 34 and a transport driven roller 36. A transport driving roller 34 is rotationally driven by a driving source (not illustrated in the drawing). In the transport portion 14, the recording medium P is transported to the belt transport portion 16 positioned downstream of the transport path 11 by being nipped between the transport driving roller 34 and the transport driven roller 36.

The belt transport portion 16 includes a first roller 38 positioned upstream in the transport path 11, a second roller 40 positioned downstream, an endless belt 42 that is rotatably and movably attached to the first roller 38 and the second roller 40, and a support 44 that supports an upper side section 42a of the endless belt 42 between the first roller 38 and the second roller 40.

The endless belt 42 is driven to move in the −X direction from the +X direction in the upper side section 42a by the first roller 38 or the second roller 40 driven by a driving source (not illustrated in the drawing). Therefore, the recording medium P transported from the transport portion 14 is further transported to the downstream of the transport path 11 in the belt transport portion 16.

The recording portion 8 includes a line-type ink jet head 48 and a head holder 46 that holds the ink jet head 48. It is noted that the recording portion 8 may be a serial type recording portion in which an ink jet head is provided on a carriage that reciprocates in the Y axis direction. The ink jet head 48 is disposed to face the upper side section 42a of the endless belt 42 supported by the support 44. The ink jet head 48 ejects the ink toward the recording medium P in a case where the recording medium P is transported in the upper side section 42a of the endless belt 42, thereby carrying out recording. The recording medium P is transported by the belt transport portion 16 to the downstream of the transport path 11 while the recording is carried out.

A first branch portion 50 is provided downstream of the belt transport portion 16 in the transport path 11. The first branch portion 50 is configured to be switchable between the transport path 11 for transporting the recording medium P to the Fd discharging portion 20 or the Fu discharging portion 26, and a reversing path 52 of the reversing path portion 24 for reversing the recording surface of the recording medium P and transporting again the recording medium P to the recording portion 8. It is noted that the recording medium P that is transported by being switched to the reversing path 52 by the first branch portion 50 has a recording surface that is reversed in the transport process in the reversing path 52, and it is transported again to the recording portion 8 such that the surface opposite to the initial recording surface faces the ink jet head 48.

Further, a second branch portion 54 is provided downstream of the first branch portion 50 along the transport path 11. The second branch portion 54 is configured to be able to switch the transport direction of the recording medium P so that the recording medium P is transported toward the Fd discharging portion 20 or the recording medium P is transported toward the Fu discharging portion 26.

The recording medium P transported toward the Fd discharging portion 20 in the second branch portion 54 is discharged from the Fd discharging portion 20 and placed on the Fd placing portion 22. In this case, the recording surface of the recording medium P is placed to face the Fd placing portion 22. In addition, the recording medium P transported toward the Fu discharging portion 26 in the second branch portion 54 is discharged from the Fu discharging portion 26 and placed on the Fu placing portion 28. In this case, the recording surface of the recording medium P is placed to face the side opposite to the Fu placing portion 28.

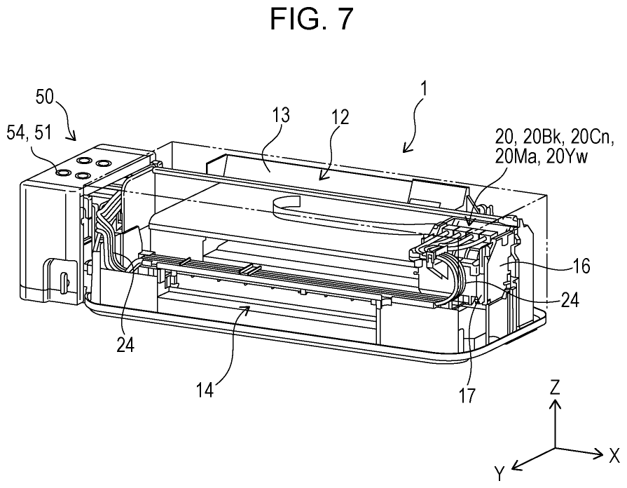

FIG. 7 is a perspective view of another example of the recording apparatus that is used in the recording method according to the present embodiment. The ink jet recording apparatus 1 in the figure includes an ink tank 50 and an ink supply pipe 24 that supplies an ink from the ink tank 50 to the ink jet head 17. A sub tank 20 that relays the ink is provided in the ink supply path between the ink tank 50 and the ink jet head 17. The sub tank 20 that relays the ink may be provided as necessary.

The ink tank 50 has an ink pouring port 54 into which ink is poured from an ink accommodating body (not illustrated in the drawing). In the present embodiment, the container of the ink accommodating body is an ink bottle, and the ink in the ink bottle is poured into the ink tank 50 from the ink pouring port 54.

The recording apparatus of the present embodiment is a recording apparatus in which the ink tank 50 is a continuous ink supply system tank (CISS tank), the ink is poured into the ink tank 50 from the ink bottle at any time, and thus the ink cartridge does not need to be exchanged, which makes it possible to carry out continuous recording without interrupting the recording.

The ink tank 50 includes, for example, four ink tanks so that four types of ink can be poured, and it also has four ink pouring ports. The number of each of the ink supply pipes 24 and the ink jet heads 17 provided are also four.

The ink jet head 17 ejects liquid droplets of the ink composition to record an image on a recording medium. In addition, the ink jet recording apparatus 1 includes a carriage 16 on which the sub tank 20 and the ink jet head 17 are mounted and which can reciprocate in an X axis direction, a paper feeding port 12 for feeding the recording medium, a paper discharge port 14 for discharging the recording medium, and a support portion 13 that supports the recording medium to be fed to the paper feeding port 12. The ink jet head 17 has a nozzle surface provided at a position facing the recording surface of the recording medium, and ejects the ink in a form of liquid droplets from a plurality of nozzles provided on the nozzle surface to adhere the ink to the recording surface of the recording medium.

The ink jet recording method of the present example may be carried out using a recording apparatus including an ink tank in which the container is an ink bottle and an ink pouring port for pouring the ink composition for ink jet from the ink bottle is provided, and an ink jet head to which the ink composition for ink jet is supplied from the ink tank, which is preferable. In this case as well, as a result, the ink is supplied from the ink bottle to the ink jet head.

### 7. Recorded Matter

The recorded matter according to the first embodiment and the second embodiment is obtained by adhering the above-described ink composition to a recording medium. The recorded matter according to the first embodiment using the above-described ink composition can be recorded with an ink having excellent color developing properties, storage stability, recovery from clogging, and continuous ejection stability.

### EXAMPLES

Hereinafter, the present disclosure will be described more specifically with reference to examples. The present disclosure is not limited in any way by the following examples.

### 1. PREPARATION OF INK COMPOSITION

The respective components were put into a tank for a mixture so that the composition described in Tables 1, 2, and 3 was obtained. Then, they were mixed and stirred and then filtered through a membrane filter to obtain an ink composition for ink jet of each example. It is noted that the numerical values of the respective components shown in the examples in the table are indicated in terms of % by mass unless otherwise specified. In addition, in the table, each numerical value indicates the solid content of the component in terms of % by mass. It is a net amount of each component, including a case of a liquid component such as an organic solvent. In the table, “plant oil CB” indicates a plant oil-derived carbon black, “petroleum CB” indicates a petroleum-derived carbon black, and “plant charcoal CB” indicates a plant charcoal-derived carbon black.

The details of the abbreviations and the product components used in Tables 1, 2, and 3 are as follows.

### Carbon Black Dispersion Liquid

CB dispersion liquids 1 to 10 (see the adjustment example below)

### Surfactant

### Surfactant A.

KF-640 (silicone-based surfactant, HLB value: 14, manufactured by Shin-Etsu Silicone Co., Ltd.)
KF-6013 (silicone-based surfactant, HLB value: 10, manufactured by Shin-Etsu Silicone Co., Ltd.)
E1010 (acetylene glycol-based surfactant, HLB value: 13 to 14, manufactured by Nissin Chemical Co., Ltd.)
EXP4200 (acetylene glycol-based surfactant, HLB value: 10 to 13, manufactured by Nissin Chemical Co., Ltd.)

### Surfactant B

SURFYNOL SE (acetylene glycol-based surfactant, HLB value: 6, manufactured by Nissin Chemical Co., Ltd.)
SURFYNOL 440 (acetylene glycol-based surfactant, HLB value: 8, manufactured by Nissin Chemical Co., Ltd.)
SURFYNOL 104 (acetylene glycol-based surfactant, HLB value: 4, manufactured by Nissin Chemical Co., Ltd.)

### Other Surfactants

E1020 (acetylene glycol-based surfactant, HLB value: 15 to 16, manufactured by Nissin Chemical Co., Ltd.)
KF-6015 (silicone-based surfactant, HLB value: 5, manufactured by Shin-Etsu Silicone Co., Ltd.)
KF-6012 (silicone-based surfactant, HLB value: 7, manufactured by Shin-Etsu Silicone Co., Ltd.)

### Organic Solvent

Glycerin (SP value: 16.7)
Propylene glycol (SP value: 14.2)
1,2-hexanediol (SP value: 12.2)
Tripropylene glycol monomethyl ether (SP value: 9.1)
Tripropylene glycol dimethyl ether (SP value: 7.4)

### pH Adjusting Agent

Triethanolamine

### Water

Ion exchange water

### Adjustment Example 1: CB Dispersion Liquid 1

Water is added to carbon black 1 (plant oil-derived carbon black (PRINTEX Nature, manufactured by Orion Engineered Carbons S.A.), BET specific surface area: 90 m²/g), and a sodium hypochlorite aqueous solution was added dropwise thereto while carrying out a pulverization treatment, thereby preparing a reaction solution containing a self-dispersing carbon black. Thereafter, filtration is carried out. Then, the pH is adjusted, and purification is carried out to obtain a CB dispersion liquid 1 of 15% by mass, which is self-dispersive. It is a self-dispersing carbon black in which the pigment surface is oxidized by the above-described treatment and a carboxyl group is introduced onto the pigment surface.

### Adjustment Examples 2 to 5: CB Dispersion Liquids 2 to 5

Plant oil-derived carbon black 2 to 5 is prepared according to a furnace method by using wood tar (manufactured by Nara Tanka Industries Co., Ltd.). The fuel is combusted to generate a high-temperature combustion gas, whereby a combustion gas flow is generated. Next, the raw material (wood tar) is introduced into the combustion gas flow to subject the plant oil to incomplete combustion and a thermal decomposition reaction, thereby obtaining carbon black. The BET specific surface area becomes smaller as the temperature of the combustion gas flow for introducing the raw material becomes lower. Therefore, a desired specific surface area is obtained by adjusting the temperature of the combustion gas flow. The BET specific surface area of carbon black 2 to 5 is as follows.
BET specific surface area of carbon black 2:90 m²/g
BET specific surface area of carbon black 3:70 m²/g
BET specific surface area of carbon black 4:30 m²/g
BET specific surface area of carbon black 5:130 m²/g

Water is added to carbon black 2, and a sodium hypochlorite aqueous solution was added dropwise thereto while carrying out a pulverization treatment, thereby preparing a reaction solution containing a self-dispersing carbon black aqueous solution. Thereafter, filtration is carried out. Then, the pH is adjusted, and purification is carried out to obtain a CB dispersion liquid 2 of 15% by mass, which is self-dispersive. The CB dispersion liquids 3 to 5 are also prepared in the same manner using the carbon black 3 to 5, respectively.

### Adjustment Example 6: CB Dispersion Liquid 6

Water is added to carbon black 6 (petroleum-derived carbon black (#850, manufactured by Mitsubishi Chemical Corporation), BET specific surface area: 220 m²/g), and a sodium hypochlorite aqueous solution was added dropwise thereto while carrying out a pulverization treatment, thereby preparing a reaction solution containing a self-dispersing carbon black aqueous solution. Thereafter, filtration is carried out. Then, the pH is adjusted, and purification is carried out to obtain a CB dispersion liquid 6 of 15% by mass, which is self-dispersive.

### Adjustment Example 7: CB Dispersion Liquid 7

Water is added to carbon black 7 (petroleum-derived carbon black (#980, manufactured by Mitsubishi Chemical Corporation), BET specific surface area: 260 m²/g), and a sodium hypochlorite aqueous solution was added dropwise thereto while carrying out a pulverization treatment, thereby preparing a reaction solution containing a self-dispersing carbon black aqueous solution. Thereafter, filtration is carried out. Then, the pH is adjusted, and purification is carried out to obtain a CB dispersion liquid 7 of 15% by mass, which is self-dispersive.

### Adjustment Example 8: CB Dispersion Liquid 8

Water is added to carbon black 8 (petroleum-derived carbon black (#52, manufactured by Mitsubishi Chemical Corporation), BET specific surface area: 88 m²/g), and a sodium hypochlorite aqueous solution was added dropwise thereto while carrying out a pulverization treatment, thereby preparing a reaction solution containing a self-dispersing carbon black aqueous solution. Thereafter, filtration is carried out. Then, the pH is adjusted, and purification is carried out to obtain a CB dispersion liquid 8 of 15% by mass, which is self-dispersive.

### Adjustment Example 9: CB Dispersion Liquid 9

Water is added to carbon black 9 (petroleum-derived carbon black (#2300, manufactured by Mitsubishi Chemical Corporation), BET specific surface area: 320 m²/g), and a sodium hypochlorite aqueous solution was added dropwise thereto while carrying out a pulverization treatment, thereby preparing a reaction solution containing a self-dispersing carbon black aqueous solution. Thereafter, filtration is carried out. Then, the pH is adjusted, and purification is carried out to obtain a CB dispersion liquid 9 of 15% by mass, which is self-dispersive.

### Adjustment Example 10: CB Dispersion Liquid 10

Water is added to carbon black 10 (plant charcoal-derived carbon black (manufactured by Kiriya Chemical Co., Ltd., powder of Kishu Binchotan charcoal), BET specific surface area: 220 m²/g), and a sodium hypochlorite aqueous solution was added dropwise thereto while carrying out a pulverization treatment, thereby preparing a reaction solution containing a self-dispersing carbon black aqueous solution. Thereafter, filtration is carried out. Then, the pH is adjusted, and purification is carried out to obtain a CB dispersion liquid 10 of 15% by mass, which is self-dispersive.

### 2. INK ACCOMMODATING BODY

### S1

A multilayer structure film in which aluminum having a thickness of 30 nm is vapor-deposited on one surface of a low density polyethylene (PE) film having a thickness of 80 μm is prepared. Thereafter, an ink pack (hereinafter, referred to as “S1”) for accommodating the ink composition is prepared by using the obtained film.

### S2

A multilayer structure film in which a nylon film having a thickness of 30 μm is laminated on one surface of a low density polyethylene (PE) film having a thickness of 80 μm is prepared. Thereafter, an ink pack (hereinafter, referred to as “S2”) for accommodating the ink composition is prepared by using the obtained film.

### S3

An ink bottle (hereinafter, referred to as “S3”) is prepared by using polyethylene through an extension blow molding. The volume of each container is set to 150 ml.

### 2.1. Amount of Dissolved Nitrogen

The above-described container is filled with each of the ink compositions for ink jet, which are prepared as described above, thereby manufacturing an accommodating body. One year after filling, the ink in the accommodating body is subjected to the measurement of the amount of dissolved nitrogen in terms of mass conversion by using a Gas Chromatograph 6890N (product name, manufactured by Agilent Technologies, Inc.). However, in Reference Example 7, the measurement is carried out immediately after the filling.

### 3. EVALUATION METHOD

### 3.1. Color Developing Properties

The accommodating body filled with the ink composition for ink jet adjusted as described above is mounted on a remodeled machine of an ink jet printer PX-H6000 (manufactured by Seiko Epson Corporation), and the ink is supplied to the ink jet head. In an example in which the ink container is S3, the CISS tank is attached to the above-described recording apparatus, and the CISS tank is filled with the ink from the ink container.

Business plain paper “KA450BZ” (A4 size) (manufactured by Seiko Epson Corporation) is set, a pattern of JEITA CP3901B is formed, and color measurement is carried out using i1 (X-Rite, Inc.). It is noted that in the printer, color correction was set to off. The black color development is evaluated as shown below based on the maximum Duty optical density (OD value) of black.

### Evaluation Standards

A: OD value is 1.20 or more.

B: OD value is 1.15 or more and less than 1.20.

C: OD value is 1.10 or more and less than 1.15.

D: OD value is less than 1.10.

### 3.2. Storage Stability

Each of the ink compositions was put into a 50 cc glass sample bottle and sealed, and the glass bottles were charged into a constant temperature tank at 50° C. and allowed to stand for 10 days in an environment at 50° C. Next, the viscosity is measured after returning the temperature to room temperature. The viscosity is determined by using a viscoelasticity tester MCR-300 (product name) manufactured by Physica, adjusting the temperature of the ink composition to 25° C., and reading the viscosity in a case where the Shear Rate is 200/sec. Then, the viscosity change rate 10 days after storage in the sample bottle with respect to the initial viscosity of the ink composition before being enclosed in the sample bottle is calculated. The evaluation standards are as follows. Regarding Reference Example 7, the viscosity change rate of the ink which is not stored is measured.

### Evaluation Standards

A: Viscosity change rate is less than ±5%.

B: Viscosity change rate is ±5% or more and less than 8%.

C: Viscosity change rate is ±8% or more and less than 11%.

D: Viscosity change rate is ±11% or more.

### 3.3. Continuous Ejection Stability

The accommodating body used for the above-described amount of dissolved nitrogen, which is allowed to stand for one year after the filling, is used to fill the recording apparatus prepared in the same manner as in the case of the color developing properties described above with the ink composition for ink jet contained in the accommodating body. Then, printer paper “P” (A4 size) manufactured by FUJI XEROX Co., Ltd. is set, and continuous printing is carried out at a resolution of 720 dpi×1,440 dpi. Nozzle checking is carried out for every five sheets, and it is checked whether or not printing can be normally carried out without omission, bending, and the like. Regarding Reference Example 7, the accommodating body immediately after filling is used.

The results of the evaluation are determined according to the following criteria and shown in the table. The evaluation standards are as follows.

### Evaluation Standards

A: 100 or more sheets can be printed normally.

B: Printing can be normally carried out in a range of 50 sheets or more and less than 100 sheets.

C: Printing can be normally carried out in a range of 5 sheets or more and less than 50 sheets.

D: Sheets of less than 5 undergo omission or flight bending.

### 3.4. Recovery From Clogging

The ink accommodating body and the recording apparatus, which are prepared in the same manner as in the case of the continuous ejection stability described above, are used. All rows of the print heads of the recording apparatus are filled with the ink, and it is confirmed that the ink is normally ejected from all the rows of the print heads. Thereafter, the ink jet printer is allowed to stand under an environment of 40° C., and 20% relative humidity for 3 days in a state where the print head is shifted from the standby position and stopped in the printing region. After being allowed to stand, the print head is returned to the standby position, and then the nozzle surface is wiped using a rubber wiper. Then, a cleaning treatment is carried out, and the number of times of cleaning taken until the ejection is recovered in all the nozzles is counted.

### Evaluation Standards

A: All nozzles are recovered by cleaning once or less.

B: All nozzles are recovered after cleaning 2 times or more and 5 times or less.

C: All nozzles are recovered after cleaning 6 times or more and 10 times or less.

D: No recovery is achieved even after cleaning 11 times or more.

### 4. EVALUATION RESULTS

Each table shows the composition and the like of the ink used in each example, and the evaluation results. From the table, in all of Examples 1 to 31 and 36 to 42 which use the ink composition containing the plant oil-derived carbon black and the petroleum-derived carbon black, where the BET specific surface area of the plant oil-derived carbon black and/or the recycled raw material-derived carbon black is 50 m²/g or more and 120 m²/g or less, and the petroleum-derived carbon black has a BET specific surface area of 160 m²/g or more and 280 m²/g or less, the color developing properties and the storage stability are excellent.

On the other hand, in all of Reference Examples 1 to 7 and Examples 32 to 35 in which at least one of the plant oil-derived carbon black and the petroleum-derived carbon black, which have the above BET specific surface area, is not contained, either color developing properties or storage stability is inferior.

In addition, from the table, in all of Examples 1 to 35 which use the ink composition for ink jet containing the plant oil-derived carbon black and the petroleum-derived carbon black and containing a surfactant A having an HLB value of 10 or more and less than 15 and a surfactant B which is an acetylene glycol-based surfactant having an HLB value of 3 or more and less than 10, the continuous ejection stability and the recovery from clogging are excellent.

On the other hand, in all of Examples 36 to 42 in which the plant oil-derived carbon black and the petroleum-derived carbon black are contained but any of the surfactant A and the surfactant B is not contained, the continuous ejection stability and the recovery from clogging are inferior.

In addition, Reference Example 5, in which the plant oil-derived carbon black is not contained and the surfactant B is not contained, the continuous ejection stability and the recovery from clogging are not inferior. From this, it can be seen that the surfactant B is necessary in a case where the plant oil-derived carbon black is contained.

In addition, Reference Example 7 has a small amount of dissolved nitrogen as compared with Reference Example 6 and has good continuous ejection stability and good recovery from clogging. From this, it can be seen that the higher the amount of dissolved nitrogen, the lower the continuous ejection stability and the recovery from clogging.

In addition, in Reference Examples 3 and 4 containing plant charcoal as a pigment, the color developing properties, the continuous ejection properties, and the recovery from clogging are inferior.

Further, although not described in the table, in a case where an ink accommodating body is prepared in the same manner as in Example 1, except that a film is prepared by attaching an aluminum foil layer having a thickness of 10 μm onto one surface of a low density polyethylene (PE) film having a thickness of 80 μm, the obtained film is used to create an ink pack in the same manner, and this container is used as an S4 container, the amount of dissolved nitrogen is 3 ppm even after a period of 1 year, and thus it can be seen that the amount of dissolved nitrogen is unlikely to increase in such a container.

What is claimed is:

1. An ink composition for ink jet comprising:
a pigment, wherein
the pigment includes a plant oil-derived carbon black and/or a recycled raw material-derived carbon black, and a petroleum-derived carbon black,
a BET specific surface area of the plant oil-derived carbon black and/or the recycled raw material-derived carbon black is 50 m²/g or more and 120 m²/g or less,
a BET specific surface area of the petroleum-derived carbon black is 160 m²/g or more and 280 m²/g or less, and
the ink composition for ink jet is an aqueous ink.

2. An ink composition for ink jet comprising:
a pigment; and
a surfactant, wherein
the pigment includes a plant oil-derived carbon black and/or a recycled raw material-derived carbon black, and a petroleum-derived carbon black,
the surfactant includes a surfactant A having an HLB value of 10 or more and less than 15 and a surfactant B which is an acetylene glycol-based surfactant having an HLB value of 3 or more and less than 10, and
the ink composition for ink jet is an aqueous ink.

3. The ink composition for ink jet according to claim 1, wherein
a total content of the plant oil-derived carbon black and/or the recycled raw material-derived carbon black is 20% by mass or more and 40% by mass or less with respect to a total amount of the plant oil-derived carbon black, the recycled raw material-derived carbon black, and the petroleum-derived carbon black.

4. The ink composition for ink jet according to claim 1, wherein
a total content of the plant oil-derived carbon black, the recycled raw material-derived carbon black, and the petroleum-derived carbon black is 4% by mass or more and 8% by mass or less with respect to a total amount of the ink composition for ink jet.

5. The ink composition for ink jet according to claim 1, wherein
the plant oil-derived carbon black and/or the recycled raw material-derived carbon black, and the petroleum-derived carbon black include a self-dispersing pigment.

6. The ink composition for ink jet according to claim 1, wherein
the ink composition for ink jet is used by being adhered to an absorbent recording medium.

7. The ink composition for ink jet according to claim 2, wherein
a mass ratio (B/A) of a content of the surfactant B to a content of the surfactant A is 0.1 or more and 1.0 or less.

8. The ink composition for ink jet according to claim 2, wherein
a content of the surfactant A is 0.18 by mass or more and 1.5% by mass or less with respect to a total amount of the ink composition for ink jet, and
a content of the surfactant B is 0.1% by mass or more and 1.0% by mass or less with respect to the total amount of the ink composition for ink jet.

9. The ink composition for ink jet according to claim 2, further comprising:
an organic solvent C having an SP value of 8 (cal/cm³)^{1/2} or more and 14 (cal/cm³)^{1/2} or less.

10. The ink composition for ink jet according to claim 9, wherein
a content of the organic solvent C is 18 by mass or more and 15% by mass or less with respect to a total amount of the ink composition for ink jet.

11. The ink composition for ink jet according to claim 9, wherein
a mass ratio (B/C) of a content of the surfactant B to a content of the organic solvent C is 0.3 or less.

12. The ink composition for ink jet according to claim 2, wherein
the surfactant A includes a silicone-based surfactant and/or an acetylene glycol-based surfactant.

13. A recording method comprising:
ejecting the ink composition for ink jet according to claim 1 from an ink jet head to adhere the ink composition for ink jet to a recording medium.
